(19) United States
(12) Patent Application Publication
(10) Pub. No.: US 2024/0075911 A1
(43) Pub. Date: Mar. 7, 2024

(54) Electronic pressure control device supplied to a railway brake caliper

(71) Applicant: ALSTOM Holdings, ST OUEN SUR SEINE (FR)

(72) Inventors: Alexandre DANDOY, MESNIL-LE-ROI (FR); Eric BONIN, JARDIN (FR); Bernard LATHUILIERE, MONTANAY (FR)

(21) Appl. No.: 18/460,573

(22) Filed: Sep. 3, 2023

(30) Foreign Application Priority Data
Sep. 6, 2022 (FR) 2208885

(51) Int. Cl. B60T 8/17; B60T 8/171; B60T 8/172; B60T 8/88; B60T 8/94; B60T 13/68; B60T 17/22

(52) U.S. Cl. CPC B60T 8/1705; B60T 8/171; B60T 8/172; B60T 8/885; B60T 8/94; B60T 13/683; B60T 17/22; B60T 2270/402; B60T 2270/88

(57) ABSTRACT

A device for regulating pressure supplied to a railway pneumatic cylinder brake caliper via an upper solenoid valve for increasing pressure and a lower solenoid valve for relieving pressure, and including a pressure regulator configured to compare a first signal representative of the pressure measured in the caliper with a second signal representative of a reference pressure, control the opening of the upper solenoid valve when the value of the first signal is lower than that of the second signal, and on the other hand, the opening of lower solenoid valve, in the presence of an emergency braking request, the second signal being representative of the pressure value needed for the emergency braking, and in the absence of such a request, the second signal being obtained from a service braking input.

### REFERENCE TO RELATED APPLICATIONS

This application is a U.S. non-provisional application claiming the benefit of French Application No. 22 08885, filed on Sep. 6, 2022, the contents of which are incorporated herein by reference in their entirety.

### TECHNICAL FIELD OF THE INVENTION

The present invention relates to an electronic device for regulating the pressure supplied to a pneumatic cylinder brake caliper of a railway rolling stock, via a pair of solenoid valves comprising an upper solenoid valve for increasing pressure and a lower solenoid valve for relieving pressure.

Railway rolling stock refers to a combination of railway vehicles suitable for moving on a railway track. Railway vehicle refers to an either motorized or non-motorized car, a locomotive or an assembly consisting of locomotives and cars, or an assembly composed of cars, the motorization of the vehicle being distributed along said cars. The rail vehicle is intended for moving on rails and conventionally includes wheels in contact with the rails.

The invention further relates to a system for regulating the pressure supplied to a pneumatic cylinder brake caliper of a railway rolling stock, via a pair of solenoid valves comprising an upper solenoid valve for increasing pressure and a lower solenoid valve for relieving pressure, the system comprising the aforementioned electronic device.

The invention further relates to railway rolling stock comprising said regulation system.

### BACKGROUND OF THE INVENTION

Most railway rolling stock, with the exception of some light rail vehicles, use a railway braking system where pneumatic energy is used for actuating the brake.

Conventionally, such a braking system is mainly composed of two elements, namely a brake control, which generates a pressure proportional to the desired braking force, and a brake caliper with a pneumatic cylinder, which uses the for pressing the pads onto the brake disc or onto the tread on the wheel.

In recent decades, pneumatic control aims to be miniaturized and, gradually, an electric control for non-safety functions has been introduced, such as the service brake function, whereas the emergency brake control, which is a safety control, currently still remains mainly pneumatic.

A direct electro-pneumatic railway braking system, as developed over the last decades, refers to an electrically controlled braking system where the service braking control command (i.e. in nominal operation mode), or even the emergency braking control command (i.e. in emergency operation mode) are electrical commands sent by an on-board computer network and/or by electrical lines following an action on a manual control dedicated to the activation of a service braking or an emergency braking by the driver of the railway vehicle, or by an autopilot system.

“Service braking” refers to the braking implemented within the railway vehicle in command, in nominal operation mode, to regulate the speed thereof throughout the trip thereof (i.e. to brake with variable strength), as well for stopping at a station.

“Emergency braking” refers to the braking used for stopping the railway vehicle in the event of a potentially dangerous situation for the railway vehicle, with a specified level of performance and safety.

So-called “compact” miniaturized pneumatic brake controls are currently generally proprietary solutions, which cannot be reconfigured without going through a complex proprietary development which is sometimes incompatible for different railway rolling stock and remain unsatisfactory in terms of compactness.

### SUMMARY OF THE INVENTION

Thereby, the goal of the invention is, in particular, to overcome existing solutions while further making the brake control more compact in order to reduce the cost and the weight thereof.

To this end, the subject matter of the invention is an electronic device for regulating the pressure supplied to a brake caliper with pneumatic cylinder of a railway rolling stock, via a pair of solenoid valves comprising an upper solenoid valve for increasing pressure and a lower solenoid valve for relieving pressure, the electronic device comprising an electronic pressure regulator configured for:
checking said pair of solenoid valves via at least one electronic control by continuously comparing a first electrical signal representative of the pressure measured within said caliper with a second electrical signal representative of a reference pressure, and
controlling the opening of:
   the upper intake solenoid valve when the value of the first electrical signal is lower than the value of the second electrical signal, or
   the lower exhaust solenoid valve when the value of the first electrical signal is greater than the value of the second electrical signal; in the presence of an emergency braking request, the second electrical signal representative of a reference pressure corresponding to an electrical signal representative of the pressure value needed for the emergency braking of the railway rolling stock,
      in the absence of an emergency braking request, said second electrical signal representative of a reference pressure corresponding to an electrical signal obtained from at least one service braking input of said device supplied by at least one electronic control unit external to said electronic device and/or supplied by a train control and monitoring system.

The architecture of the electronic device proposed according to the present invention is used for replacing most of the pneumatic components of the brake control by substitute electronic components, including for the safety control function of the emergency braking. Indeed, the present invention takes advantage of the strong similarity between electricity and pneumatics by considering that the voltage is equivalent to the pressure, and that the electric current is equivalent to the air flow-rate, so that according to the present invention any pneumatic component has an electrical equivalent.

More precisely, the present invention consists in replacing the usual pneumatic elements by equivalent electric or digital elements implemented within said device according to the present invention, in command advantageously to control a single pair of pneumatic solenoid valves, one for increasing the pressure in the brake cylinder, the other for decreasing same.

According to other advantageous aspects of the invention, the electronic device for regulating the pressure supplied to a brake caliper with pneumatic cylinder of a railway rolling stock, via a pair of solenoid valves comprising an upper solenoid valve for increasing pressure and a lower solenoid valve for relieving pressure, comprises one or a plurality of the following characteristics, taken in isolation or in all technically feasible combinations:
the electronic device further comprises:
   a first acquisition module configured for:
      receiving said first electrical signal representative of said measured pressure, said first electrical signal being supplied by a first pressure transmitter external to said electronic device, said first pressure transmitter being configured to convert the measured pressure, within said caliper, into said first electrical signal, and
      supplying said first electrical signal to the input of said electronic regulator,
   a reconfigurable memory space configured for:
   storing said electrical signal representative of the pressure value needed for the emergency braking of said railway rolling stock,
   supplying said electrical signal representative of the pressure value needed for the emergency braking to the input of said electronic regulator, in the presence of an emergency braking request
at least one second acquisition module configured for:
   receiving and/or generating said electrical signal obtained from at least one service braking input of said device supplied by at least one electronic control unit external to said electronic device and/or supplied by a train monitoring and control system, and
   supplying said electrical signal obtained to the input of said electronic regulator, in the absence of an emergency braking request;
the device further comprises:
   a third acquisition module configured for:
      receiving a third electrical signal representative of the pressure measured within a suspension associated with said brake caliper, said third electrical signal being supplied by a second pressure transmitter external to said electronic device, said second pressure transmitter being configured to convert the measured pressure, within said suspension, into said third electrical signal, and
      supplying said third electrical signal to the input of at least one load compensation module,
   at least one load compensation module configured for determining the pressure value needed for an emergency braking, or needed for an immobilization braking of said railway rolling stock according to the load of said railway rolling stock of which the third electrical signal is representative;
said first pressure transmitter and/or said second pressure transmitter being directly integrated into said electronic device using a pneumatic tube directly connected between said device and said caliper and/or said suspension, respectively;
the device further comprising a forced regulation module, configured for acquiring at least two distinct types of commands for:
   forcing the inlet solenoid valve into the closed state, or
   forcing the exhaust solenoid valve into the open state, said at least two commands being issued by an electronic brake control unit external to said electronic device, said electronic brake control unit being configured to detect a sliding of the wheels of said rolling stock, and to control said sliding by means of said solenoid valve forcing commands, said forced regulation module being further configured for converting said acquired command into a forced regulation command which has priority with respect to the electronic control supplied as output by the electronic pressure regulator and intended for said pair of solenoid valves;
the device further comprising a hysteresis module configured for:
   comparing the value of the first electrical signal with a predetermined threshold representative of a limit before overpressure within said caliper, and
   if said threshold is crossed, generating a pressure relief command, which has priority over the forced regulation command, and is intended for said pair of solenoid valves;
the device further comprising a fourth acquisition module configured for:
   receiving a signal representative of the absence of pressure in an indirect cylinder when the brake caliper is a parking brake caliper comprising two brake cylinders: a direct cylinder dedicated to non-parking braking and an indirect cylinder dedicated to parking braking of the railway rolling stock;
   generating a pressure relief command, which has priority over the forced regulation command, and intended for said pair of solenoid valves;
the electronic control sent by default to said pair of solenoid valves being a pressure inlet control, when the brake caliper comprises a direct cylinder dedicated to the service braking and to the emergency braking, or a pressure relief control, when the brake caliper is a parking brake caliper comprising only one indirect cylinder dedicated at the same time to the service braking, to the emergency braking and/or to the parking brake;
the device further comprising a timer module configured for establishing a minimum transition time between two distinct states of the pair of solenoid valves, said two distinct states being associated with the application of two distinct electronic controls;
the device further comprising an automatic test module configured for automatically initiating an automatic test of said device, and/or an automatic test of the pair of solenoid valves, and/or of said brake caliper;
the device further comprising a fault monitoring module configured for at least monitoring the device's own internal power supply;
the device further comprising
   an accelerometer configured for measuring the longitudinal acceleration of said railway rolling stock,
   a combination module configured for combining said longitudinal acceleration with a speed of said railway rolling stock supplied by an electronic brake control unit external to said electronic device and generating a consolidated speed suitable for being used by at least said load compensation module.

A further subject matter of the invention is a system for regulating the pressure supplied to a pneumatic cylinder brake caliper of a railway rolling stock, via a pair of solenoid valves comprising an upper solenoid valve for increasing pressure and a lower solenoid valve for relieving pressure, the system comprising at least:
an electronic device as described hereinabove;
said pair of solenoid valves.

According to an advantageous aspect, the system further comprises a relay valve having a 1:1 regulation rate, said relay valve being located between the pair of solenoid valves and the pneumatic cylinder brake caliper, the pair of solenoid valves being configured for generating a pilot pressure to be applied to said relay valve which is configured as such for then amplifying the output flow, according to a predetermined amplification, intended for the pneumatic cylinder brake caliper.

A further subject matter of the invention is a railway rolling stock comprising the aforementioned regulation system.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a schematic representation of an electronic device for regulating the pressure supplied to a pneumatic cylinder brake caliper of a railway rolling stock according to a simplified embodiment of the present invention, and

FIG. 2 is a schematic representation of an electronic pressure regulation device according to different variants of the present invention.

### DETAILED DESCRIPTION

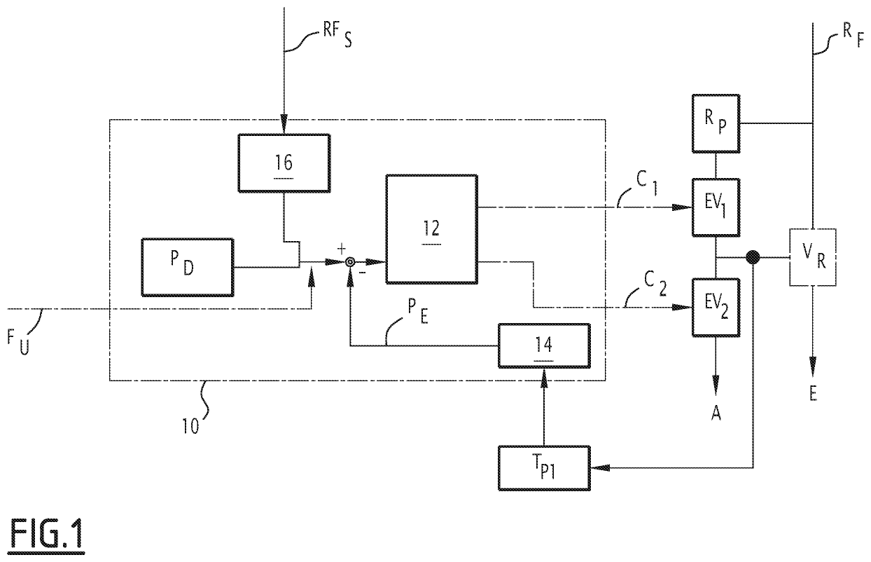

FIG. 1 is a schematic representation of a regulation system for the pressure supplied to a pneumatic cylinder brake caliper E of a railway rolling stock, via a pair of solenoid valves comprising an upper inlet solenoid valve EV₁ for increasing pressure and a lower exhaust solenoid valve EV₂ for relieving pressure according to a simplified embodiment.

More precisely, according to the present invention, such a pressure regulation system comprises an electronic device 10 for regulating the pressure supplied to the caliper E of a pneumatic cylinder brake, said electronic device 10 comprising an electronic pressure regulator 12.

Such an electronic pressure regulator 12 is configured for controlling said pair of solenoid valves EV₁ and EV₂ via at least one electronic control by permanently comparing a first electrical signal PE representative of said pressure within said caliper E with a second electrical signal representative of a reference pressure. It should be noted that the first electrical signal PE representative of said pressure within said caliper E is obtained by measurement directly at the output of the pressure regulation system 12 after the pair of solenoid valves EV₁ and EV₂ as shown in FIG. 1 (everything being connected by piping).

In addition, the electronic pressure regulator 12 is configured for controlling, via the command C₁, the opening of the upper solenoid valve EV₁ when the value of the first electrical signal is lower than the value of the second electrical signal, or via the command C₂, the lower solenoid valve EV₂ when the value of the first electrical signal is greater than the value of the second electrical signal, considering that in the presence of an emergency braking request F_{U}, the second electrical signal [being] representative of a reference pressure corresponding to an electrical signal representative of the pressure value needed for the emergency braking of said railway rolling stock, and in the absence of an emergency braking request F_{U}, said second electrical signal representative of a reference pressure corresponding to an electrical signal (i.e. analog or digital) RFs obtained from at least one service braking input of said device 10 supplied by at least one electronic control unit external to said electronic device 10 and/or supplied by a train control and monitoring system (TCMS).

According to an example of architecture illustrated in FIG. 1, the electronic regulation device 10 further comprises in particular, a first electronic acquisition module 14. The first electronic acquisition module 14 is configured for receiving said first electrical signal representative of said measured pressure, said first electrical signal being supplied by a pressure transmitter T_{P1} external to said electronic device 10, said first pressure transmitter T_{P1} being configured to convert the measured pressure within said caliper E into said first electrical signal P_{E} and to supply said first electrical signal PE to the input of said electronic regulator 12.

The electronic device 10 further comprises a reconfigurable memory space PD. Such reconfigurable memory space PD is configured for storing said electrical signal representative of the pressure value needed for the emergency braking of said railway rolling stock, and configured for supplying said electrical signal representative of the pressure value needed for the emergency braking to the input of said electronic regulator 12, in the presence of an emergency braking request F_{U}.

According to the simplified embodiment shown in FIG. 1, the electronic device 10 further comprises at least a second acquisition module 16 configured for receiving said electrical signal from an input 15 supplied by control electronic unit external to said electronic device 10 or supplied by a train monitoring and control system and supplying said electrical signal to the input of said electronic regulator 12, in the absence of an emergency braking request.

In other words, the electronic pressure regulator 12 controls the two solenoid valves EV₁ and EV₂. If the pressure in the brake caliper cylinder is too low, the electronic pressure regulator 12 sends an electrical command C₁, e.g. a bit with a value of zero (or conversely with a value of one) to the upper solenoid valve EV₁, in order to intake air coming from a source of pressure (typically a brake reservoir R_{F} followed by a pressure reducer R_{P} as illustrated in FIG. 1).

Conversely, when the pressure is too high in the brake caliper cylinder, the electronic pressure regulator 12 sends a command C₂, e.g. a bit with a value of one (or conversely with a value of zero) to the upper solenoid valve EV₂, in order to release the pressure into the atmosphere A.

To this end, the electronic pressure regulator 12 constantly compares the reference pressure with the actual pressure of the brake caliper cylinder, the actual pressure being measured via the pressure transmitter T_{P1} external to said electronic device 10. The external pressure transmitter T_{P1} is configured to supply the first electrical signal P_{E} representative of said pressure measured within said caliper E, to the first electronic acquisition module 14 of the regulation device 10.

By default, the reference pressure stored within the reconfigurable memory space PD is the pressure needed for the emergency braking in order to ensure the safety of the system. If the emergency braking is not required, then the reference pressure corresponds to an electrical signal RFS obtained from at least one service braking input, via said second acquisition module 16 of said device 10 supplied by at least one electronic control unit external to said electronic device 10 and/or supplied by a train control and monitoring system (TCMS).

In other words, the emergency braking request acts as a switch for imposing the reference pressure stored within the reconfigurable memory space P_{D} when an emergency braking is required.

It should be noted that the architecture of the device 10 according to the present invention is innovative insofar as all the functions implemented within the device 10 via the elements 12, 14, 16 and PD are implemented electronically and not by means of a pneumatic circuit such as is conventionally done, including for the management of the emergency braking, and advantageously by using a single pair of solenoid valves. Thereby, the present invention makes it possible to reduce the number of pneumatic components, the cost, the weight, the volume needed for the pressure regulation while also providing a better integration.

According to a variant of embodiment (not shown), the electronic pressure regulation device 10 is and/or comprises a secured electronic board and comprises a data processing unit consisting e.g. of a memory comprising in particular the reconfigurable memory space PD, and of a processor associated with the memory.

According to said variant of embodiment, the electronic pressure regulator 12, the first acquisition module 14, the second acquisition module 16 are each produced in the form of a programmable logic component, such as an FPGA (Field Programmable Gate Array), where an FPGA is not considered as software but as hardware, or as an integrated circuit, such as an ASIC (Application specific Integrated Circuit).

According to another variant of embodiment, in order to achieve the level of safety required for the emergency braking, a duplication of the critical functions is needed and e.g. implemented using a processor (integrating software, the electronic pressure regulator 12, the first acquisition module 14, the second acquisition module 16, each then being implemented in the form of software) backed-up by an FPGA as described hereinabove.

Advantageously, due to the entirely electronic nature thereof, the parameter of the electronic pressure regulation device 10 can be set in the factory, in particular in order to reconfigure same (i.e. to adapt same) to each specific application of the rolling stock considered, wherein the electronic device will be taken on-board.

It should be noted that according to a first variant of the simplified embodiment shown in FIG. 1, the two solenoid valves for the intake and the exhaust (i.e. the release) of the air, are produced by a single component with two electrical inlets: one for the command C₁ of the inlet and one for command C₂ of the exhaust. Thereby, such variant has a more compact pair of solenoid valves which provide a better integration.

According to a second optional variant of the simplified embodiment shown in FIG. 1, the system for regulating the pressure supplied to a caliper E further comprises a relay valve having e.g. a 1:1 regulation rate (i.e. 1:1 ratio indicating that the outlet pressure is equal to the pilot pressure received at the inlet from the pair of solenoid valves EV₁ and EV₂ while supplying at the outlet a flow-rate higher than the flow-rate received at the inlet, as the output flow-rate is limited only by the characteristics of the downstream circuit. As an alternative the output pressure is not necessarily equal but proportional to the pilot pressure received at the input). Said relay valve is located between the pair of solenoid valves EV₁ and EV₂ and the pneumatic cylinder brake caliper E, the pair of solenoid valves EV₁ and EV₂ being configured for generating a pilot pressure to said relay valve as such configured for then amplifying the output flow (i.e. via the generation of a higher air flow) according to a predetermined amplification for the pneumatic cylinder brake caliper E. In other words, the relay valve is itself configured for filling the pneumatic cylinder of the caliper E to a pressure equal to the pilot pressure and with a flow-rate higher than the flow-rate supplied to the inlet by the pair of solenoid valves EV₁ and EV₂. The relay valve is thus a source of pressure, which imposes a pressure to the circuit and thereby reduces the air flow-rate upstream into the pair of solenoid valves EV₁ and EV₂. The size, the cost and the electrical consumption of the solenoid valves EV₁ and EV₂ are advantageously reduced.

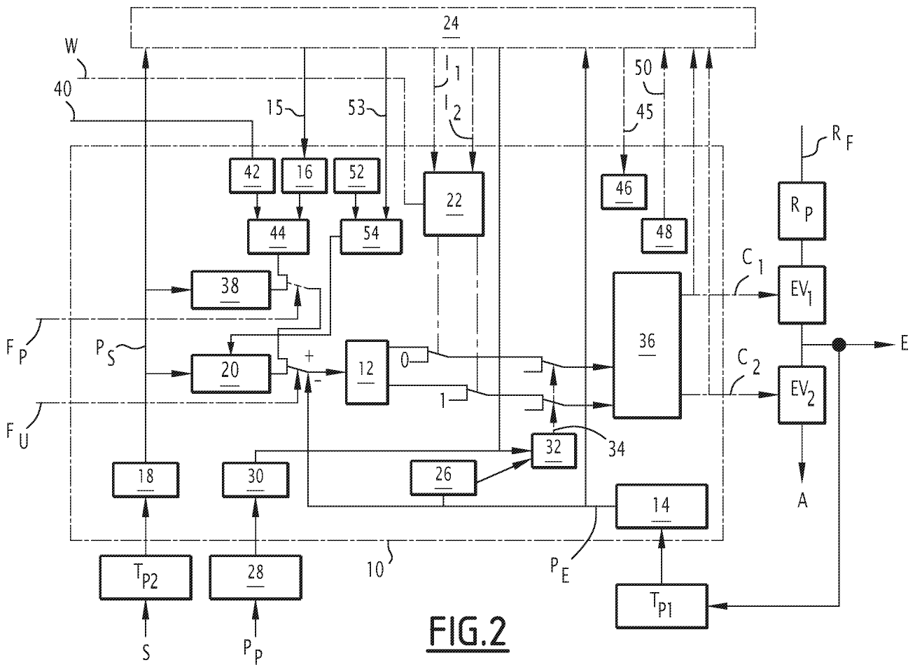

FIG. 2 is a schematic representation of an electronic pressure regulation device according to different variants of the present invention, the different variants being shown cumulatively in the embodiment shown in FIG. 2. As an alternative, each variant described hereinafter could be optionally added independently to the simplified embodiment shown in FIG. 1 and described hereinabove.

According to a first optional variant, the electronic regulation device 10 further comprises a third acquisition module 18 configured for receiving a third electrical signal P_{S} representative of the pressure measured within a suspension S associated with said brake caliper E, said third electrical signal being supplied by a second pressure transmitter T_{P2} external to said electronic device 10. Said second pressure transmitter T_{P2} is configured to convert the measured pressure within said suspension S into said third electrical signal, and to supply the third electrical signal at the input of at least one load compensation module 20.

Moreover, according to the first variant described in relation with FIG. 2, the electronic regulating device 10 further comprises said at least one load compensation module 20 configured for determining the pressure value needed for the emergency braking of said railway rolling stock according to the load of said railway rolling stock of which the third electrical signal is representative.

In other words, according to the first variant, the default pressure reference used in the case of emergency braking is compensated by the load (i.e. the pressure reference is a linear function of the load, the parameters of the linear function also being stored in memory and being parameterizable according to the application), and not constant and stored in a memory space as illustrated in FIG. 1. In practice, the pressure inside the suspension bellows S, the pressure being an image of the load of the railway rolling stock (i.e. train), is measured with the pressure transmitter T_{P2}. The output signal of the pressure transmitter T_{P2} is then acquired by the third acquisition module 18 of the secured electronic board of the regulation device 10 and used as input for a load compensation function implemented by the load compensation module 20, which sets the pressure reference in the event of an emergency braking.

It should nevertheless be noted that abnormal measurements of pressure in the suspension S (too high or too low, e.g. because the pressure transmitter T_{P2} is faulty or because the suspension cushion is punctured) are ignored (i.e. the linear function is then clipped).

Such a load compensation in emergency braking advantageously makes it possible to always obtain the same deceleration, and thus the same braking distance, whatever the load of the railway rolling stock (i.e. train), as required in particular in certain markets.

According to a second optional variant, which can be combined with the preceding variant or which can only be combined with the simplified embodiment shown in FIG. 1, the electronic regulation device 10 further comprises a forced regulation module 22, configured for acquiring at least two distinct types of commands I₁ and I₂ used for:
forcing the inlet solenoid valve EV₁ into the closed state I₁, and/or
forcing the exhaust solenoid valve EV₂ into the open state I₂, said at least two commands being issued by an electronic brake control unit 24 external to said electronic device 10, said electronic brake control unit 24 being configured to detect a sliding of the wheels of said railway rolling stock, and to control said sliding by means of said commands for forcing the solenoid valves EV₁ and EV₂, e.g. apt:
to issue, in the presence of said sliding, said commands I₁ and I₂ to force the decrease of the brake force,
once said sliding is stabilized, to issue said command to lock the brake force at the current value (I₁ and not I₂) thereof,
to issue, in the absence of said sliding, said command (not I₁ and not I₂) to force the increase of the brake force up to the value corresponding to the reference pressure of the regulator 12.

The forced regulation module 22 is further configured for converting said acquired command into a forced regulation command which has priority over the electronic command supplied at the output by the electronic pressure regulator 12 and intended for said pair of solenoid valves EV₁ and EV₂.

As an alternative (not shown), the forced regulation module 22 is further configured for converting said acquired command into a forced regulation command supplied at the input of the electronic pressure regulator 12. In other words, according to such variant, not shown in FIG. 2, it is also possible to make the outputs of the module 22 act directly on the reference pressure (at the inlet of the module 12) and not on the outlet of the module 12.

In other words, according to the second optional variant, the secured electronic board [of the] regulation device 10 has two additional inputs, namely the distinct commands I₁ and I₂ to prevent the intake, or to force the exhaust.

The inputs I₁ and I₂ are typically used during the implementation of a wheel slide protection (WSP) algorithm by the external electronic brake control unit 24 (also known as the electronic Brake Control Equipment (BCE)) so as to force brake release (i.e. air exhaust) when sliding is detected, which bypasses (overrides by having priority over) the outlet of the pressure regulator 12 as illustrated in FIG. 2 where the outlets of the forced regulation module 22 are configured to modify the outlets of the pressure regulator 12 downstream.

When the sliding has disappeared, the wheel slide protection (WSP) algorithm then allows the regulator 12 to quickly restore the brake pressure in the cylinder of the brake caliper E.

In order to guarantee safety, the command to force the inlet solenoid valve EV₁ to the closed state is ignored if same lasts e.g. more than fifteen seconds as per the standard requirement of the standard EN15595, such duration being parameterizable in particular according to another example by means of a threshold duration value well below fifteen seconds, and a watchdog fault W is generated and sent by the electronic safety board of the electronic device 10, in order to be used e.g. by the Train Control and Monitoring System (TCMS). Optionally, the same applies if the command to force the exhaust solenoid valve EV₂ to the open state lasts more than ten seconds. In addition, if a command to force the exhaust solenoid valve EV₂ to the open state (I₂) is received without a command to force the inlet solenoid valve EV₁ to the closed state (I₂ and not I₁), which would carry the risk to empty the brake reservoir into the atmosphere, then such commands will be ignored.

Such a second optional variant makes it possible to omit the solenoid valve conventionally called a “dump valve” which is used traditionally for wheel slide protection (WSP).

According to a third optional variant supplementary to the preceding variant, the regulation device 10 further comprises a hysteresis module 26 configured for:
comparing the value of the first electrical signal with a predetermined threshold representative of a limit before overpressure within said caliper, and
if said threshold is crossed, generating a pressure relief command, which has priority over the forced regulation command, and is intended for said pair of solenoid valves.

In other words, according to the third variant, an additional electronic function is implemented in the electronic safety board of the regulation device 10. The electronic function implemented via the hysteresis module 26 will force the air to escape if the measured pressure exceeds a given threshold with a predetermined hysteresis. Such a third optional variant makes it possible to protect the caliper E against an overpressure in the brake cylinder, which could damage same. Such function provides additional safety, and can also replace the pressure reducer RP which is usually mounted after the brake reservoir RF.

A fourth additional optional variant is proposed in particular for railway rolling stocks, some brake calipers of which are called “parking brake calipers”, because same incorporate additional features for keeping the railway rolling stock stationary even when there is no more pressure available on the railway rolling stock, i.e. when the railway rolling stock is parked for a long period of time, e.g. for several hours.

In general, about half of the brake calipers are parking brake calipers (also called parking brakes). Normal brake calipers have only one brake cylinder, of the direct type, with force proportional to pressure. The parking brake calipers have two brake cylinders, one direct (like normal brake calipers), and one indirect with force inversely proportional to pressure, by means of an additional spring.

When the railway rolling stock is parked for a long time, all the pneumatic circuits are at atmospheric pressure, and the force is provided by the spring, which prevents any movement of the railway rolling stock (i.e. train). During the running of the railway rolling stock (e.g. train), the indirect cylinder is pressurized so as to cancel the spring force, and the brake is controlled only by the direct cylinder, like in normal brake calipers. With such solution, there is a risk that the two cylinders generate a force at the same time, which could damage the caliper E. To prevent such risk, an “anti-compound” valve is conventionally added and is suitable for preventing the application of pressure in the direct cylinder when there is no pressure in the indirect cylinder.

The fourth additional optional variant proposed herein aims at enabling the “anti-compound” valve to be removed by replacing same with an additional function in the electronic safety board. To this end, the regulation device 10 further comprises, connected to an external pressure switch 28 (i.e. pressure switch 28), a fourth acquisition module 30 configured for:
receiving a signal issued by the external switch 28, representative of the absence of pressure in an indirect cylinder when the brake caliper is a parking brake caliper comprising two brake cylinders: a direct cylinder dedicated to non-parking braking and an indirect cylinder dedicated to parking braking of the railway rolling stock;
generating a pressure relief command, which has priority over the forced regulation command, and intended for said pair of solenoid valves.

In other words, by means of the pressure switch 28 indicating the absence of pressure in the indirect cylinder, the electronic safety board of the regulation device 10 will force the exhaust of air into the direct cylinder in order to prevent the superposition of the forces.

As an alternative (not shown), the pressure switch 28 of the system illustrated by FIG. 2 is replaced by another pressure transmitter.

As illustrated in FIG. 2, according to a particular aspect, the electronic safety board of the regulation device 10 further comprises a module 32 corresponding to a logical OR for generating a relief command 34, which has priority over the forced regulation command, issued by the hysteresis module 26 or by the fourth acquisition module 30.

As an alternative to the aforementioned fourth additional optional variant, according to a fifth additional optional variant (not shown), the electronic command sent by default to said pair of solenoid valves is a pressure intake command, when the brake caliper comprises a direct cylinder dedicated to the service braking and to the emergency braking, or a pressure relief command, where the brake caliper is a parking brake caliper comprising only an indirect cylinder dedicated at the same time to the service braking, the emergency braking and/or the parking brake.

The fifth variant of the electronic device 10 further simplifies the parking brake caliper by removing the direct cylinder of the parking brake caliper, the indirect brake cylinder then being used for both the service brake and for the emergency brake.

According to the fifth variant, the aforementioned operation of the regulating device 10 remains the same except for the fact that the operation imposes that the default state of the solenoid valves EV₁ and EV₂ has to be the exhaust to the atmosphere, and a reversing of the binary logic values (zero and one) commands C₁ and C₂, with in particular the value one for the air intake and the value zero for the exhaust, so that the result of the electronic command sent by default results in an application of force by the caliper.

The fifth variant also allows the “anti-compound” valve to be removed and reduces the cost of the parking brake caliper, which then comprises only one brake caliper.

According to a sixth additional optional variant, the regulation device 10 further comprises a timer module 36 configured for establishing a minimum duration of transition between two distinct states of the pair of solenoid valves, said two distinct states being associated with the application of two distinct electronic controls.

In other words, according to the sixth additional optional variant, an additional electronic function is added to the electronic safety board of the regulation device 10 so as to make sure that the solenoid valves EV₁ and EV₂ are not activated and deactivated too quickly, in particular, by checking a minimum activation time and a minimum deactivation time. The sixth additional optional variant also leads to making sure that a minimum transition time is ensured between the intake and the exhaust of the air, and vice versa.

More precisely, the module 36 uses e.g. at least three parameters:
t_off_min corresponding to the minimum duration for which the solenoid valve remains closed (i.e. the solenoid valve control has to remain at zero for at least t_off_min);
t_on_min corresponding to the minimum duration for which the solenoid valve remains open (i.e. the solenoid valve control has to remain at one for at least t_on_min)
t_dead corresponding to the minimum duration between the closing of EV₁ (EV₂, respectively) and the opening of EV₂ (EV₁, respectively)=>the two solenoid valves can never be opened simultaneously, so we go through a minimum time (t_dead) during which the two solenoid valves are closed.

The sixth additional optional variant thus makes it possible to optimize the lifetime of the solenoid valves EV₁ and EV₂, as well as to reduce the need for maintenance.

According to a seventh additional optional variant, the regulation device 10 further comprises a duplicated emergency braking input and a second load compensation module 38 associated with said duplicated emergency braking input. Such a seventh additional optional variant is suitable for being used in certain markets (high-speed trains e.g.) requiring two levels of force because the grip varies with speed (less braking is applied at high speed), hence the duplication of “emergency braking” inputs: the first input will be applied first, then the second input will be applied once the speed drops below a certain threshold).

Like for the load compensation module 20, if the pressure in the suspension (measured by TP₂) is outside the range provided for by the design, then default pressures are applied, which could be different for the modules 20 and 38. The above can happen e.g. in the event of a faulty TP₂ sensor, or if the suspension cushion is punctured. In other words, the linear load pressure compensation function is clipped in the upper and lower parts thereof, so as to provide protection against an abnormal suspension pressure measurement.

Such a seventh additional optional variant is also suitable for being used for obtaining a holding brake function F_{P} (i.e. a safe holding) used for keeping the railway rolling stock (e.g. the train) at standstill for a short period of time, usually in train stations. Usually, the parking brake is obtained by applying the service brake and by turning off the traction (for safety reasons). Due to the safety provided by the control of the electronic safety board 10, the level of integrity of the safety of the traction cut-off can be reduced.

According to an eighth additional optional variant, the input and the acquisition of the signal for the pressure reference of the service brake are duplicated and represented by the input 40 and the acquisition module 42. The second input 40 corresponds e.g. to the emergency service brake pressure reference supplied by another set of electronic brake control equipment (BCE) or supplied by the pressure of the brake pipe (as defined in EN 14478). Such an input 40 is suitable for being used according to said variant, e.g. in the event of a failure of the control electronic unit 24 which generates the input 15, for increasing the overall availability of the system, which in particular is currently required in the Indian rail markets.

The inlet 40 can also be used for emulating (i.e. replacing) the conventional brake valve, by adding a pressure transmitter measuring the brake pipe pressure fitted to conventional trains, meeting e.g. the UIC or AAR standards for braking, distributed throughout the train. The pressure in the main line brake pipe is inversely proportional to the braking force requested by the driver. The function of the manifold is to generate the pressure for the cylinder of brake caliper, from the pressure of the brake pipe. Manifolds are generally heavy and expensive components. The eighth additional optional variant then makes it possible to replace the manifold by a simple pressure transmitter connected to the secured electronic board.

It should be noted that the electronic safety board 10 aims to give priority to emergency braking over the rest (i.e. Fu has priority over F_{P} which as such has priority over the aforementioned inputs 15 and 40), and for this purpose further comprises an indicator 44 configured for determining the maximum value input amongst the inputs 15 and 40, the output of the indicator 44 then being connected to two switches connected to the outputs of the load compensation modules 20 and/or 38, respectively, in order to use Fu with priority when emergency braking is required, and then, by order of priority, the holding braking F_{P} (in the absence of required emergency braking) then the maximum value input amongst the inputs 15 and 40 (in the absence of emergency braking Fu or of holding braking F_{P}), so as to define the reference pressure to be used.

As an alternative (not shown), the indicator 44 is located after said (i.e. downstream of said) two switches. The effect is similar to the upstream location shown in FIG. 2, since the emergency brake force is greater than the service brake force.

According to a ninth additional optional variant, the regulation device 10 further comprises an automatic test module 46 configured for automatically starting an automatic test of said device, and/or an automatic test of the pair of solenoid valves EV₁ and EV₂, and/or of said brake caliper E. In other words, according to the ninth additional optional variant, an additional electronic function is added to the electronic safety board in order to carry out an automatic test of the board, of the solenoid valves EV₁ and EV₂ and of brake caliper E. The level of the safety integrity of the electronic board 10 forming the regulation device is thereby increased. The automatic test is started automatically each time the electronic safety board 10 is switched on or can be started by an external electronic control unit 24 as illustrated by the command 45 in FIG. 2.

According to a tenth additional optional variant, the electronic regulation device 10 further comprises a fault monitoring module 48 configured for at least monitoring the own internal power supply of said device, and performing a transfer 50 of the monitoring result to an external electronic control unit 24, in order to be consolidated with the other information on the health status of the braking system of the railway rolling stock (i.e. train).

In other words, according to the tenth additional optional variant, the secured electronic board 10 comprises an additional function of monitoring faults, such as e.g. monitoring the internal power supply thereof. Said function helps diagnose problems during testing and/or during commercial service (i.e. operation with passengers).

According to an eleventh additional optional variant, the electronic regulation device 10 further comprises an accelerometer 52 configured for measuring the longitudinal acceleration of said railway rolling stock, and a combination module 54 configured for combining said longitudinal acceleration with a speed of said railway rolling stock supplied by the electronic brake control unit 24 external to said electronic device 10 and for generating a consolidated speed suitable for being used by at least said load compensation module 20.

In other words, according to the eleventh additional optional variant, the accelerometer 52 is optionally added to the electronic safety board 10. The integration of the longitudinal acceleration delivered by the accelerometer, combined with the speed 53 supplied by the brake control electronics BCE 24 (or directly from a speed transmitter (not shown), is used for generating, via the combination module 54, a reliable speed reference. The reliable speed reference is then used by the load compensation module 20 for adapting the pressure reference in the emergency brake depending on the speed. A variable brake pressure reference is advantageously suitable for being used for obtaining a variable brake force in the emergency brake so as to cope with the wheel-rail coefficient of adhesion, which changes with speed, as required by the Technical Specifications for Interoperability (TSI). Such a variable braking pressure reference can also be used for compensating for the coefficient of friction, e.g. between the disc and the brake pad, which also depends on the speed.

According to a twelfth additional optional variant, the secured electronic board forming the electronic regulation device 10 refers to another electronic control unit, e.g. to the electronic brake control equipment BCE 24 of the data as listed hereinbelow as an example, but not limited to:
the pressure measured in the cylinder of the brake caliper E.
the control of the solenoid valves EV₁ and EV₂,
the pressure in the suspension bellows S in particular when the first optional variant shown in FIG. 2 is used;
the condition of the parking brake caliper if the fourth additional optional variant is used, or the pressure in the indirect cylinder of the parking brake caliper if the pressure switch 28 of the system according to said variant is replaced by a pressure transmitter;
the accelerations along the three directions x, y, z of a predetermined reference frame, in particular when the eleventh additional optional variant is used;
various monitoring data if the tenth additional optional variant is used.

Such transfers implemented by the electronic regulating device 10 are used for developing any type of more complex functions in the electronic control unit such as protection against slipping under traction, or braking against jamming or sliding of the wheels, in particular according to the standard EN14478, the load compensation for the service brake, conditional maintenance, predictive maintenance, brake combination, slope compensation, etc. In other words, such transfers are used for developing any type of function not related to safety, or with a lower level of safety integrity, without redesigning/re-certifying the secured electronic board of the electronic device 10.

As an alternative, according to such twelfth additional optional variant, the exchange of data, including the pressure reference for the service brake, between the electronic safety board 10 and the electronic control unit 24 takes place through a network, e.g. a Controller Area Network, which reduces wiring.

According to a thirteenth additional optional variant, said first pressure transmitter TP₁ and/or said second pressure transmitter TP₂, and/or the external pressure switch 28 (i.e. the pressure switch 28) are directly integrated into said electronic device by using a pneumatic tube connected directly between said device and said caliper E and/or said suspension S, respectively.

In other words, the pressure transmitters described hereinabove are directly integrated into the secured electronic board 10. In other words, a pneumatic tube is connected directly between the secured electronic board 10 and the pressure to be measured. The mechanical integration on the component side is thereby simplified, for a limited additional complexity on the secured electronic board as such. In this way it is also possible to remove the pressure transmitters from areas highly exposed to electromagnetic interference, making it easier to demonstrate EMC.

The secured electronic board 10 according to the present invention makes it possible to use the redundancies needed for guaranteeing the level of safety integrity required for the emergency braking, by associating in particular, in a redundant way, a secured electronic board 10 (i.e. a pressure regulating device according to the present invention) with each brake caliper or group of brake calipers.

According to an aspect (not shown), it should be noted that the secured electronic board 10 (i.e. a pressure regulation device according to the present invention) is designed in such a way that any failure, or most of the failures, such as a failure of the electrical power supply, systematically leads to the intake of air into the brake cylinder (or to the exhaust in the case of an indirect brake cylinder like in the fifth variant), controlled e.g. by an electronic signal of zero binary value (i.e. a bit with the value zero), and leading to the application of a braking force.

Moreover, in a secure manner, the secured electronic boards 10 (i.e. a pressure regulation device according to the present invention) associated with each brake caliper or group of brake calipers, do not have a common failure mode (i.e. are independent). In other words, the pressure regulating device is designed so that a failure in one device does not lead to a failure in another device.

One of the conventional common modes, in particular for the pneumatic braking control system, is the emergency braking control Fu. To avoid same, when the emergency brake line drops to zero (the most likely failure mode thereof), the secured electronic board 10 is configured for systematically applying the emergency brake.

Another classic common mode is the design of the board as such. Indeed, since the design of the secured electronic board is the same for all boards, a design fault can lead to the same failure on all boards at the same time. Such pitfall is prevented by standard tests and the application of standards, as is done conventionally for the control system of pneumatic brakes.

In order to guarantee an adequate safety integrity level (SIL), the regulation system according to the present invention is designed in such a way that, for the solenoid valves EV₁ and EV₂, if there is no command, i.e. a zero command, which occurs e.g. in the event of a failure of the electrical power supply to the secured electronic board, the upper solenoid valve EV₁ will be open by default, and the lower solenoid valve EV₂ will be closed. In other words, the (direct) brake cylinder will be put in direct communication with the reservoir, which will thus result in braking. In the fifth variant, the reverse is true: the (indirect) brake cylinder is vented to the atmosphere, which also results in braking.

It should be noted that it is possible to achieve the highest level of safety (SIL4) by means of redundant and diversified software or software backed-up by an FPGA, which amounts to a control by software and to a control of the result via another device (i.e. not a software).

Moreover, the pressure regulator 12 is designed in such a way that in the event of a component failure, the air intake (the exhaust, respectively, in the case of the fifth variant) will be the default control.

If the “emergency brake” line of train Fu falls to zero, which is most probable failure case thereof, the pressure regulator 12 is configured for regulating the default pressure reference needed for the emergency braking.

The pressure transmitter T_{P1} normally delivers an electrical signal having a current comprised between 4 and 20 mA. An abnormal current (typically 0 mA) is suitable for being detected by the electronic safety board 10 and for being interpreted as insufficient pressure, which will force the upper solenoid valve EV₁ to intake more air.

The optional load compensation module 20 (and thus the acquisition module 18, the accelerometer 52 and the combination module 54 which supply same with input data) is designed in such a way that, in the event of a failure, a default pressure (corresponding e.g. to the maximum braking pressure) is generated and used as a reference by the pressure regulator 12.

The optional forced regulation module 22 ensures that the WSP algorithm cannot prevent air intake or force air exhaust (which would result in a reduction in the braking force) for more than 10 s (as required by the standards). The optional forced regulation module 22 is designed in such a way that in the event of a breakdown, the output of the pressure regulator 12 is used by default for controlling the solenoid valves EV₁ and EV₂.

The failure modes of the other modules not having any direct impact on safety, such as the acquisition module 16 used only for the service braking which is not related to safety, are also analyzed in order to ensure that same cannot have a negative impact on the other aforementioned modules which ensure the safety of the railway rolling stock.

A person skilled in the art would understand that the invention is not limited to the embodiments described, nor to the particular examples of the description, the above-mentioned embodiments and variants being suitable for being combined with one another so as to generate new embodiments of the invention.

Thereby, the present invention proposes an electropneumatic architecture for the brake control, which makes it possible to replace most of the pneumatic components of the brake control by equivalent electronic components, even for the safety function such as the emergency braking. In the invention, all pneumatic components are used for both the service braking and the emergency braking, which makes it possible to have just a pair of solenoid valves for ensuring the pressure regulation, and the level of safety integrity required for emergency braking is ensured by a secured electronic board forming the proposed electronic regulation device 10.

1. An electronic device for regulating the pressure supplied to a pneumatic cylinder brake caliper of a railway rolling stock, via a pair of solenoid valves comprising an upper solenoid valve for increasing pressure and a lower solenoid valve for relieving pressure, the electronic device comprising an electronic pressure regulator configured for:
checking the pair of solenoid valves via at least one electronic control by continuously comparing a first electrical signal representative of the pressure measured within the caliper with a second electrical signal representative of a reference pressure, and
controlling the opening of:
the upper intake solenoid valve when the value of the first electrical signal is lower than the value of the second electrical signal; and
the lower exhaust solenoid valve when the value of the first electrical signal is greater than the value of second electrical signal, wherein:
in the presence of an emergency braking request, the second electrical signal being representative of a reference pressure corresponding to an electrical signal representative of the pressure value needed for emergency braking of the railway rolling stock, and
in the absence of an emergency braking request, the second electrical signal being representative of a reference pressure corresponding to an electrical signal obtained from at least one service braking input of the device supplied by at least one electronic control unit external to the electronic device or supplied by a train control and monitoring system.

2. The electronic device according to claim 1, further comprising:
a first acquisition module configured for:
receiving the first electrical signal representative of the measured pressure, the first electrical signal being supplied by a first pressure transducer external to the electronic device, the first pressure transducer being configured to transform the measured pressure, within the caliper, into the first electrical signal, and
supplying the first electrical signal to the input of said electronic pressure regulator;
a reconfigurable memory space configured for:
storing the electrical signal representative of the pressure value needed for the emergency braking of the railway rolling stock, and
supplying the electrical signal representative of the pressure value necessary for the emergency braking to the input of said electronic pressure regulator, in the presence of a request for emergency braking; and
at least a second acquisition module configured for:
receiving or generating the electrical signal obtained from at least one service braking input of the device supplied by at least one electronic control unit external to the electronic device or supplied by a train monitoring and control system, and
supplying the electrical signal obtained to the input of said electronic pressure regulator, in the absence of an emergency braking request.

3. The electronic device according to claim 2, wherein the first pressure transmitter or the second pressure transmitter are directly integrated into the electronic device using a pneumatic tube directly connected between the device and the caliper or the suspension.

4. The electronic device according to claim 2, further comprising a forced control module configured for acquiring at least two distinct types of commands for:
forcing the inlet solenoid valve into the closed state, or
forcing the exhaust solenoid valve into the open state, the at least two commands being issued by an electronic brake control unit external to the electronic device, the electronic brake control unit being configured to detect a sliding of the wheels of the rolling stock, and to control the sliding by means of the forcing commands for the solenoid valves, the forced regulation module being further configured for converting the acquired command into a forced regulation command which has priority with respect to the electronic command supplied as output by the electronic pressure regulator and intended for the pair of solenoid valves.

5. The electronic device according to claim 4, further comprising at least a hysteresis module configured for:
comparing the value of the first electrical signal with a predetermined threshold representative of a limit before overpressure within the caliper, and
if the threshold is crossed, generating a pressure relief command, which has priority over the forced regulation command, and is intended for the pair of solenoid valves.

6. The electronic device according to claim 4, further comprising a fourth acquisition module configured for:
receiving a signal representative of the absence of pressure in an indirect cylinder when the brake caliper is a parking brake caliper comprising two brake cylinders: a direct cylinder dedicated to non-parking braking and an indirect cylinder dedicated to parking braking of the railway rolling stock;
generating a pressure relief command, which has priority over the forced regulation command, and intended for the pair of solenoid valves.

7. The electronic device according to claim 1 further comprising:
a third acquisition module configured for:
receiving a third electrical signal representative of the pressure measured within a suspension associated with the brake caliper, the third electrical signal being supplied by a second pressure transmitter external to the electronic device, the second pressure transmitter being configured to convert the measured pressure, within the suspension, into the third electrical signal, and
supplying the third electrical signal to the input of at least one load compensation module; and
the at least one load compensation module configured for determining the pressure value needed for emergency braking, or needed for immobilization braking of the railway rolling stock, depending on the load of the railway rolling stock of which the third electrical signal is representative.

8. A system for regulating pressure supplied to a pneumatic cylinder brake caliper of a railway rolling stock, via solenoid valves, the system comprising:
an electronic device according to claim 1; and
a pair of solenoid valves, comprising:
an upper solenoid valve for increasing pressure; and
a lower solenoid valve for relieving pressure.

9. The electronic system according to claim 8, further comprising a relay valve having a 1:1 regulation rate, the relay valve being located between said pair of solenoid valves and the pneumatic cylinder brake caliper,
said pair of solenoid valves being configured for generating a pilot pressure to said relay valve which is configured as such for then amplifying the output flow, according to a predetermined amplification, intended for the pneumatic cylinder brake caliper.

10. A railway rolling stock comprising a system according to claim 8.
